(19) United States
(12) Patent Application Publication
(10) Pub. No.: US 2017/0321316 A1
(43) Pub. Date: Nov. 9, 2017

(54) PROCESS FOR APPLYING ANTI-GALLANT COATING WITHOUT MASKING

(71) Applicant: United Technologies Corporation, Farmington, CT (US)

(72) Inventor: Alan C. Barron, Jupiter, FL (US)

(21) Appl. No.: 15/150,084

(22) Filed: May 9, 2016

(51) Int. Cl. C23C 4/12; C23C 18/32; B05D 1/02

(52) U.S. Cl. CPC C23C 4/12; B05D 1/02; C23C 18/32

(57) ABSTRACT

A method for applying anti-gallant coating to metal parts utilizes an ultrasonic sprayer driven by a precise manipulation device such as a robotic arm for high efficiency and precision. The method does not require masking adjacent or nearby metal parts, decreases time and money spent applying the anti-gallant coating, and is environmentally friendly.

### BACKGROUND

When metals are attached to each other, a form of wear called galling can occur between the surfaces where they are connected or adhered. When metals gall, the material is pulled with the contacting surface over time. This is caused by a combination of friction and adhesion between the surfaces, followed by a tearing of crystal structure. This can leave some materials friction welded to adjacent surfaces. Metals in particular gall due to their atomic structures. Galling can occur on metal surfaces where there is a lack of lubrication between the surfaces.

In many industries, including aerospace, medical devices, oil and gas, and fasteners, galling is prevented by the used of anti-gallant coatings. Anti-gallant coatings are chemical coatings applied to the surface of metals which are connected and prevent later galling. Anti-gallant coatings can have a variety of chemical compositions and are used to protect specific metal parts from galling. The anti-gallant coating chemically reacts with adjacent metal parts when stress is applied to the adhesion.

The application of anti-gallant coatings has previously been accomplished by mechanical means such as brushes, sponges and rollers, in addition to air sprays. These methods are cumbersome both because they are imprecise and may result in poor quality coatings which adhere to other parts of the item, not just the metal parts of interest. Mechanical methods that require a human hand to apply the coating, such as brushes or sponges, may miss parts, apply the coating unevenly, or get the coating on unwanted areas. Traditional air sprays are also imprecise, as a large amount of the coating ends up in the atmosphere as opposed to on the surface of interest. Additionally, overspray resulting from air sprays or similar methods creates uneven coatings, leaving a signature and feathering on the edges of the coated part.

Industry methods have long used masking to prevent other parts from being touched or coated during the anti-gallant coating method. Masking is a time-consuming preparation process in which parts of the device are covered or “masked” to prevent the application of anti-gallant coating to that part. This process greatly increases the time and money spent to apply anti-gallant coatings to certain metal parts. If masking is done improperly, there is additional cost of poor quality when the device must be cleaned and the anti-gallant coating re-applied to the correct areas, if the device can be used after improper masking.

Today, industry standards for applying anti-gallant coatings use mechanical methods which can cause inconsistencies, thick coatings, imprecise applications, feathering on edges, and require masking of nearby metal parts when the substrate is being coated.

### SUMMARY

A method for applying anti-gallant coating to parts, the method comprising: providing a precise manipulation device having an ultrasonic sprayer thereon, the ultrasonic sprayer configured to dispense anti-gallant material; positioning a part to receive anti-gallant material dispensed by the ultrasonic sprayer; and activating the ultrasonic sprayer to apply the anti-gallant material to the part according to a spray path executed by the precise manipulation device, to form an anti-gallant coating on the part.

A system for applying anti-gallant coating to parts, the system comprising: a container for holding a supply of anti-gallant material; an ultrasonic nozzle connected to the container, the ultrasonic nozzle configured to dispense the anti-gallant material; and a precise manipulation device configured to move the ultrasonic nozzle with respect to a part along a spray to deposit an anti-gallant coating on a defined area or areas of the part.

A coated part comprising: a substrate, and an ultrasonically applied anti-gallant coating on the substrate, wherein the anti-gallant coating has a uniform thickness and has substantially no feathering at an edge of the anti-gallant coating.

### BRIEF DESCRIPTION OF THE DRAWINGS

FIG. 1 is a perspective view of an ultrasonic sprayer attached to a robotic arm spraying a metal sheet with anti-gallant coating.

FIG. 2 is a flow chart of a method of applying an anti-gallant coating to a part without masking.

### DETAILED DESCRIPTION

Leveraging ultrasonic nozzle technology and high precision machines, such as robotic arms, to apply anti-gallant coatings to substrates allows not only for higher precision in coatings, but also for evenly, consistently applied coatings without feathering that will wear at the same rate, less environmental harm due to minimal coating release into the atmosphere, and the elimination of the need of masking, resulting in lower costs and time.

Previous methods have not used high precision instruments, such as ultra-sonic nozzles, or robotic arms, to apply anti-gallant coatings. High precision ultra-sonic nozzles, such as those disclosed in U.S. Pat. No. 9,242,049, offer a coating spray which is much more precise than traditional paint spray nozzles. Unlike traditional spray nozzle systems, ultrasonic spray nozzle systems are more environmentally friendly due to their higher precision and resulting lower waster.

Similarly, anti-gallant coating methods have not leveraged technology such as precision devices or robotic arms. Precision devices such as gantry, six-axis or selective-compliance-articulated robotic arms, cam-operated articulable arms, or computer numerical control machines, are many times more precise than the human hand, and allow for repeatable, consistent coatings.

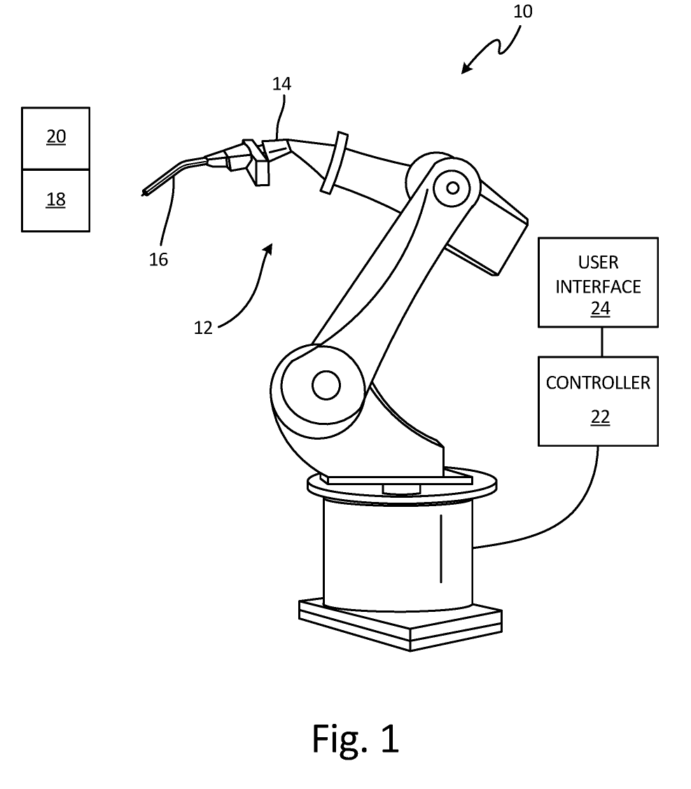

FIG. 1 is a schematic diagram of system 10 for applying anti-gallant coating. System 10 includes robotic arm 12, container 14, ultrasonic nozzle 16, substrates 18, 20, controller 22 and user interface 24.

Robotic arm 12 is an example of a high precision device used to apply precise, even coatings. In FIG. 1, robotic arm 12 is a gantry robot which had three prismatic joints and whose axes coincide with Cartesian coordinates. Robotic arm 12 can be programmed through user interface 24, and both movement of the arm and release of spray can be controlled through programming. Robotic arm 12 can be a gantry, a six-axis or a selective-compliance-articulated robot arm (SCARA). A gantry arm, also known as a Cartesian arm, is a mechatronic device which uses motors and linear actuators to position a tool, such as an ultrasonic nozzle. A gantry arm makes movements along X, Y and Z coordinates. A SCARA arm similarly moves along X, Y, and Z axes but may also incorporate a θ axis. Six-axis arms offer more directional control and are similar to the human arm in movement style, but with higher precision. All three types offer accuracy ranges if at least 0.1 mm, while varying versions of gantry arms can be as precise as 10 μm. Alternatively, the precision device could be any type of robotic device useable for spray coating application, such cam-operated articulable arms or a computer numerical control (CNC) machine, which are simpler and may be programmed with a repeatable set of movements.

Container 14 holds an anti-gallant coating. Anti-gallant coatings are used particularly with stainless steel and other corrosion-resistant metal alloys which are prone to galling. Galling is a severe form of adhesive wear which occurs due to the transfer of material between sliding surfaces. Metallic surfaces are prone to galling particularly when there is poor lubrication. This occurs in a variety of industries and metal parts, including engine bearings, hydraulic cylinders, gas turbine vanes and blades, valves, screw threads, pistons and actuators. Anti-galling coatings can include hard anodized coatings, silver plated coatings, thermal spray coatings, electroless nickel coatings, dry lubrications, and many other industry-specific coatings.

Ultrasonic nozzle 16 is attached to robotic arm 12. Ultrasonic nozzles allow for the application of precise, thin film coatings without feathering effects. While traditional mechanical methods such as rollers or brushes create thick or uneven coatings, traditional pressure nozzle spray applications are imprecise and leave up to ninety percent of the coating material dispersing in the air around the substrate instead of sticking to the substrate. Ultrasonic nozzle sprayers, in contrast, produce a fine mist spray which is focused. Ultrasonic nozzles atomize liquids using high frequency sound waves, which are outside of the human hearing range, rather than forcing liquid through a small orifice as in traditional pressure spray nozzles. Ultrasonic nozzles result in a more uniform dispersion of coating particles in very thin layer due to the suspension of the particles in the nozzle throughout spraying. Commercially available ultrasonic nozzles allow for adjustment of the spray pattern within 1.78 mm to 25 mm, depending on the specific nozzle. This reduces over-spraying, which both reduces atmosphere contamination and prevents a feathering effect on the edges of the sprayed part, allowing for an evenly distributed coating without any signature.

Substrate 18 is an example of a metal part which is to be coated with anti-gallant coating. Many metals, including aluminum and stainless steel, can gall easily, while others, such as steel or brass, are less prone to galling. Substrate 20 is an example of a metal part which is attached to substrate 18, but should not be coated with anti-gallant coating. In prior art, substrate 20 would be masked to prevent application of the anti-gallant coating to that part. Masking is a method of protecting certain parts of an item from exposure to the coating. With masking, certain parts are painstakingly covered or sealed off to ensure no coating comes into contact with those parts. Incorrect masking can lead to further problems and repeated attempts to apply anti-gallant coatings. However, with the use of a high-precision system for applying the coating, substrate 20 does not need to masked, saving time, money, and potential errors.

Controller 22 is used to control the movement of the robotic arm and the spray of the ultrasonic nozzle. Controller 22 may be either programmable through user interface 24, or controlled directly by the user to create a path for robotic arm 12 to follow. Specifically, controller 22 is complex enough to allow coating of substrate 18 but not coating of substrate 20. User interface 24 allows programming and control of robotic arm 12. Once programmed, controller 22 includes memory that stores instructions and data (programming) that allows robotic arm 12 to be moved precisely along a defined path to replicate application of the anti-gallant coating on multiple parts.

System 10 can be used to apply anti-gallant coatings of varying thickness to small, specific areas of substrates without masking.

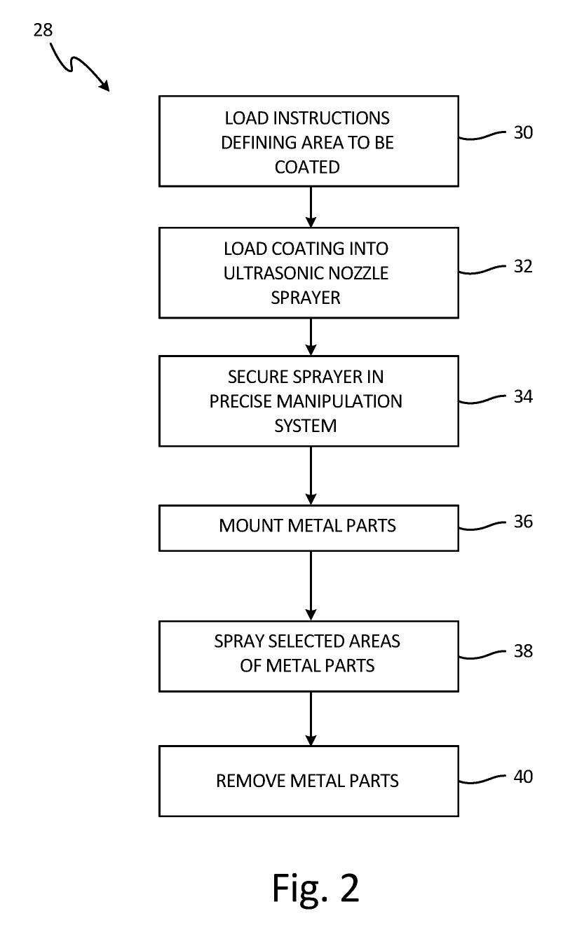

FIG. 2 is a flow chart of method 28 for applying an anti-gallant coating to a metal part without masking. Method 28 includes loading instructions (step 30), loading container (step 32), securing sprayer (step 34), mounting metal parts (step 36), spraying metal parts on area of interest (step 38), and removing metal parts (step 40).

Method 28 begins with step 30, when the user programs a precise manipulation device. As discussed earlier, the precise manipulation device may be a robotic arm, such as arm 12 pictured in FIG. 1, any other type of camera operated articulable arm, or a CNC device. Depending on the requirements for the particular type of device, the programming step may include programming a simple, repeatable set of movement and spraying, or it may be complex.

Next, in step 32, the user loads the anti-gallant coating into the ultrasonic sprayer, such as sprayer 16 pictured in FIG. 1. Here, the user can select one of many types of anti-gallant coatings, depending on the substrate being coated. This can include hard anodized coatings, silver plated coatings, thermal spray coatings, electroless nickel coatings, dry lubrications, and many other industry-specific coatings, which work differently with varying substrates.

In step 34, the user secures the ultrasonic sprayer to the precise manipulation device. The ultrasonic sprayer must be secure such that the movement of the precise manipulation device will not shake the ultrasonic sprayer, altering the spray pattern. The ultrasonic sprayer can be secured through fasteners, clasps, or any other reasonable method for attachment to the manipulation device.

Next, in step 36 the items to be coated are placed in range of the precise manipulation device. In FIG. 1, the example given is substrate 18. Once the substrate is secured, there is no need to mask unwanted parts. Instead, the precise manipulation device can be programmed specifically, with more precision than a human hand, to spray only parts that should be coated with the anti-gallant coating. Even without masking, the high precision of the ultrasonic sprayer and precise manipulation device prevent feathering on the edges of the substrate.

In step 38, the program for the precise manipulation device should be run, carefully controlling both spray and movement. This process can be completed in a “quiet” environment, as the ultrasonic sprayer does not produce waste associated with traditional pressure sprayers and there is no need to keep a fan or vacuum to eliminate that waste. The coating that is applied to the part will be thin, even, and will not contain a signature such as feathering. Finally, once coating is completed, the substrates or other coated items should be removed from their stationary position (step 40).

The present invention can produce a coating that is uniform in thickness, which is defined as thickness with less than twenty percent variation. Additionally, there is substantially no feathering along the edges of the coating, or any other signature left by the coating method, that can occur when other methods are utilized.

Method 28 presents unique benefits in the anti-gallant coating process that have not previously been addressed. First, the method presented does not require masking. Currently, masking in anti-gallant coating processes is more time, energy and money consuming than applying the anti-gallant coating itself. The use of the ultrasonic spray system eliminates the need for masking because of its high accuracy and precision. Additionally, the use of a robotic arm or other manipulation device allows for higher precision and repeatability than using a human hand to apply the coating. Moreover, the coating that is applied to the substrate is uniform in thickness, and can be applied very thinly to materials on which a thick coating is not desired. Finally, the use of a quiet environment in which there is no aerosol waste is an environmental improvement.

### DISCUSSION OF POSSIBLE EMBODIMENTS

The following are non-exclusive descriptions of possible embodiments of the present invention.

A method for applying anti-gallant coating to parts, the method comprising: providing a precise manipulation device having an ultrasonic sprayer thereon, the ultrasonic sprayer configured to dispense anti-gallant material; positioning a part to receive anti-gallant material dispensed by the ultrasonic sprayer; and activating the ultrasonic sprayer to apply the anti-gallant material to the part according to a spray path executed by the precise manipulation device, to form an anti-gallant coating on the part.

The method of the preceding paragraph can optionally include, additionally and/or alternatively, any one or more of the following features, configurations and/or additional components:

Providing a precise manipulation device includes securing the ultrasonic sprayer to the precise manipulation device.

The method includes loading instructions in a controller, wherein the instructions specify movement of the precise manipulation device and spraying of the ultrasonic sprayer, and wherein the instructions define the spray path, and executing the instructions in the controller to control movement of the precise manipulation device and operation of the ultrasonic sprayer to spray anti-gallant material onto a defined area or areas of the part.

The controller controls the precise manipulation device and the ultrasonic sprayer to produce a coating with a non-feathered edge.

The method includes spraying the anti-gallant material onto the part in a low-wind environment.

The precise manipulation device is configured to achieve positional accuracy within a range of 10 μm to 0.1 mm.

The precise manipulation device comprises at least one of a robotic arm or a computer numerical control.

The anti-gallant coating comprises a hard anodized coating, a silver plated coating, a thermal spray coating, an electroless nickel coating, or a dry lubrication.

The ultrasonic sprayer is configured to adjust spray of the anti-gallant material within a spray width of 1.78 mm to 25 mm.

A system for applying anti-gallant coating to parts, the system comprising: a container for holding a supply of anti-gallant material; an ultrasonic nozzle connected to the container, the ultrasonic nozzle configured to dispense the anti-gallant material; and a precise manipulation device configured to move the ultrasonic nozzle with respect to a part along a spray to deposit an anti-gallant coating on a defined area or areas of the part.

The system of the preceding paragraph can optionally include, additionally and/or alternatively, any one or more of the following features, configurations and/or additional components:

The system includes a controller containing a memory configured to store and deliver instructions, wherein the instructions specify movement of the precise manipulation device and spraying of anti-gallant material by the ultrasonic nozzle.

The controller controls the precise manipulation device and the ultrasonic nozzle to produce the anti-gallant coating with a non-feathered edge.

The ultrasonic nozzle is configured to spray anti-gallant material onto the part in a low-wind environment.

The precise manipulation device comprises at least one of a robotic arm or a computer numerical control.

The precise manipulation device is configured to achieve positional accuracy within a range of 10 μm to 0.1 mm.

The anti-gallant coating comprises a hard anodized coating, a silver plated coating, a thermal spray coating, an electroless nickel coating, or a dry lubrication.

The ultrasonic nozzle is configured to adjust spray of the anti-gallant material within a spray width of 1.78 mm to 25 mm.

A coated part comprising: a substrate, and an ultrasonically applied anti-gallant coating on the substrate, wherein the anti-gallant coating has a uniform thickness and has substantially no feathering at an edge of the anti-gallant coating.

The part of the preceding paragraph can optionally include, additionally and/or alternatively, any one or more of the following features, configurations and/or additional components:

The anti-gallant coating comprises a hard anodized coating, a silver plated coating, a thermal spray coating, an electroless nickel coating, or a dry lubrication.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method for applying anti-gallant coating to a part, the method comprising:
providing a precise manipulation device having an ultrasonic sprayer thereon, the ultrasonic sprayer configured to dispense anti-gallant material;
positioning a part to receive anti-gallant material dispensed by the ultrasonic sprayer; and
activating the ultrasonic sprayer to apply the anti-gallant material to the part according to a spray path executed by the precise manipulation device, to form an anti-gallant coating on the part.

2. The method of claim 1, wherein providing a precise manipulation device includes securing the ultrasonic sprayer to the precise manipulation device.

3. The method of claim 1, and further comprising:
loading instructions in a controller, wherein the instructions specify movement of the precise manipulation device and spraying of the ultrasonic sprayer, and wherein the instructions define the spray path; and
executing the instructions in the controller to control movement of the precise manipulation device and operation of the ultrasonic sprayer to spray anti-gallant material onto a defined area or areas of the part.

4. The method of claim 3, wherein the controller controls the precise manipulation device and the ultrasonic sprayer to produce a coating with a non-feathered edge.

5. The method of claim 1, and further comprising spraying the anti-gallant material onto the part in a low-wind environment.

6. The method of claim 1, wherein the precise manipulation device is configured to achieve positional accuracy within a range of 10 μm to 0.1 mm.

7. The method of claim 1, wherein the precise manipulation device comprises at least one of a robotic arm or a computer numerical control.

8. The method of claim 1, wherein the anti-gallant coating comprises a hard anodized coating, a silver plated coating, a thermal spray coating, an electroless nickel coating, or a dry lubrication.

9. The method of claim 1, wherein the ultrasonic sprayer is configured to adjust spray of the anti-gallant material within a spray width of 1.78 mm to 25 mm.

10. A system for applying anti-gallant coating to a part, the system comprising:
a container for holding a supply of anti-gallant material;
an ultrasonic nozzle connected to the container, the ultrasonic nozzle configured to dispense the anti-gallant material; and
a precise manipulation device configured to move the ultrasonic nozzle with respect to a part along a spray to deposit an anti-gallant coating on a defined area or areas of the part.

11. The system of claim 10, further comprising a controller containing a memory configured to store and deliver instructions, wherein the instructions specify movement of the precise manipulation device and spraying of anti-gallant material by the ultrasonic nozzle.

12. The system of claim 11, wherein the controller controls the precise manipulation device and the ultrasonic nozzle to produce the anti-gallant coating with a non-feathered edge.

13. The system of claim 10, wherein the ultrasonic nozzle is configured to spray anti-gallant material onto the part in a low-wind environment.

14. The system of claim 10, wherein the precise manipulation device comprises at least one of a robotic arm or a computer numerical control.

15. The system of claim 10, wherein the precise manipulation device is configured to achieve positional accuracy within a range of 10 μm to 0.1 mm.

16. The system of claim 10, wherein the anti-gallant coating comprises a hard anodized coating, a silver plated coating, a thermal spray coating, an electroless nickel coating, or a dry lubrication.

17. The system of claim 10, wherein the ultrasonic nozzle is configured to adjust spray of the anti-gallant material within a spray width of 1.78 mm to 25 mm.

18. A coated part comprising:
a substrate; and
an ultrasonically applied anti-gallant coating on the substrate, wherein the anti-gallant coating has a uniform thickness and has substantially no feathering at an edge of the anti-gallant coating.

19. The coated part of claim 18, wherein the anti-gallant coating comprises a hard anodized coating, a silver plated coating, a thermal spray coating, an electroless nickel coating, or a dry lubrication.
